(19) United States
(12) Patent Application Publication
(10) Pub. No.: US 2025/0283276 A1
(43) Pub. Date: Sep. 11, 2025

(54) SYSTEM FOR DECOLORIZATION OF MATERIAL COMPRISING CELLULOSE

(71) Applicant: ANDRITZ OY, Helsinki (FI)

(72) Inventors: Tiina HAATAINEN, Varkaus (FI); Taina LINTUNEN, Kotka (FI); Elina AHONEN, Kotka (FI); Hannu RÅMARK, Kotka (FI); Kari VANHATALO, Kotka (FI)

(21) Appl. No.: 19/105,008

(22) PCT Filed: Aug. 18, 2023
(86) PCT No.: PCT/FI2023/050475

§ 371 Date: Feb. 19, 2025

(30) Foreign Application Priority Data
Aug. 19, 2022 (FI) 20225735

(51) Int. Cl. D21C 9/153; C08J 11/08; D06B 21/00; D21C 9/02; D21C 9/16

(52) U.S. Cl. CPC D21C 9/153; C08J 11/08; D06B 21/00; D21C 9/02; D21C 9/163; C08J 2301/02

(57) ABSTRACT

A system for decolorization of material comprising cellulose including: a purification stage for removing non-cellulosic components from cellulose in alkaline process conditions; a first decolorization stage for decolorizing the material comprising cellulose in alkaline process conditions; and a second decolorization stage for decolorizing the cellulose in alkaline process conditions; wherein the first and second decolorization stages use ozone and hydrogen peroxide; wherein the purification stage and the second decolorization stage include washing the cellulose, wherein the purification stage, the first decolorization stage and the second decolorization stage are connected to the subsequent stage by a process line for feeding the cellulose; and wherein each washing arrangement is connected to the washing arrangement of a preceding stage by a filtrate line for feeding wash filtrate of the washer of a preceding stage.

### TECHNICAL FIELD

The present disclosure generally relates to a system for processing material comprising cellulose. In particular, but not exclusively, the present disclosure relates to a system for processing material comprising cellulose selected from the group of chemical pulp, recycled textiles, agro fibers, nonwood fibers, cardboard and textile scraps, pieces or garments. In particular, but not exclusively, the present disclosure relates to a system for processing textile material. In particular, but not exclusively, the present disclosure relates to a system for processing material comprising cellulose in chemical bases using alkaline processes for manufacturing purified and decolorized material.

### BACKGROUND

This section illustrates useful background information without admission of any technique described herein being representative of the state of the art.

Circular economy thinking is nowadays everyday life. It has become an industrial standard way. In textile industry circular economy is seen today in a form of new processes and new companies acting in the textile industry area.

Presently, there are basically two chemical textile fiber processes used in industry, traditional viscose process and Lyocell process. Both processes need purified cellulosic raw material called dissolving pulp to work. Further processes to compete against current methods are being developed, for example ionic liquid base processes, cellulose carbamate process and cellulose activation processes using cold alkali dissolution.

Instead of using virgin wood based dissolving pulp raw material, it is possible to purify recycled textile, textile leftover pieces, etc. to manufacture pulp corresponding to dissolving pulp. Consumer textile waste and other used textile scraps/pieces/garments is first processed in a mechanical separation process to discard non-cellulosic components like zippers and buttons. Plastic material like polyester and elastane is subsequently removed, cellulosic material is decolorized using chemical means, and in the end, the result is a recycled textile-based pulp having analogue properties to dissolving pulp.

In chemical pulping technology typical decolorizing chemicals are chlorine dioxide (ClO₂), oxygen (O₂), hydrogen peroxide (H₂O₂), and ozone (O₃). Typically, ClO₂ and O3 work in an acid environment, whereas O₂ and H₂O₂ in an alkaline environment. For example, known literature teaches the use of acidic conditions in ozone stage for positive influence on lignin removal and for protecting cellulose (Sixta, H. et al. Pulp bleaching-Ozone delignification, Handbook of pulp, ed. Sixta, H. pp 777-848, 2006).

It is common to carry out chemical pulp bleaching in a pulp mill fiberline using a system in which acid and alkali decolorizing stages are sequentially ordered. A different order does not provide a sufficient bleaching result. After each decolorizing stage the pulp is washed. Wash filtrates are circulated countercurrently backwards so that the acid filtrate is processed to a preceding acid stage, and alkali filtrate to a preceding alkali stage. If acid and alkali wash filtrate flows are mixed, it will cause precipitation problems in process equipment leading to process shutdowns, or foaming causing considerable operating problems. In chemical pulp, lignin and chromophore compounds are components against which the decolorizing chemicals are acting.

Textile materials are made usually from pure cotton, polycotton, cotton containing elastane, or from manmade cellulosic fibers such as viscose or Lyocell or as combination of previously mentioned materials. Accordingly, the base raw material is relatively pure cellulose which is already processed so that no lignin, chromophores, or other natural color inducing components remain. However, it is common that color compounds are added to textiles to give a desired appearance, shininess and further features. Typical color compounds are reactive black, reactive orange, direct blue, direct red and vat blue. Hence, in the case of textiles, decolorizing effect is different than in the case of chemical pulp. Chemical nature of color compounds is totally different from that of lignin and accordingly a different procedure is needed, for example an alkaline ozone stage, to carry out the decolorizing effectively with desired results. Trevizani, J. et. al. shows that using alkaline conditions in ozone bleaching provides a faster and more efficient dye removal (Trevizani, J. L. B., Nagalli, A., Passig, F. H., Carvalho, K. Q. de, Schiavon, G. J., & Model, A. N. de L. (2018). Influence of pH and concentration on the decolorization and degradation of BR red azo dye by ozonization. Acta Scientiarum. Technology, 40 (1)).

There are also previous patent publications relating to decolorizing chemical pulp, and to purification of recycled textile material.

Patent FI123299 presents a chemical pulp mill fiber line bleaching system with acid and alkaline process stages. In presented systems washing filtrate is taken out from the system in several places and countercurrent washing is not fully used. Washing water is added to the end and to the middle of the process thus increasing fresh water usage. Acid-alkaline alternate system is causing a situation in which it is possible that a preceding stage with a different pH is affecting the following stage chemical consumption increasing it.

WO2020251463 discloses a process where recycled textile material is treated with alkali and using other process chemical stages resulting cellulose material to be fed to dissolution processes. Used stages are working in alkaline and in acid pH areas limiting optimal wash filtrate circulating arrangement.

WO20180731177 discloses a process for recycled textile for manufacturing dissolving pulp like material. Process has an alkaline stage following bleaching stages O₂, and O3 but ozone stage is done in acid media and does not give possibilities to process wash filtrates to preceding stages without having known problems like precipitation or foaming problems.

WO2019140245 discloses a method in which recycled textile is treated in a subcritical process having acid or alkaline pH following decolorizing stage using solvents. The process stage is working in different pH levels having water based and solvent-based systems. This makes it difficult to utilize filtrate circulation system for wash filtrates, increasing water consumption and material amounts. It is also notable that solvent media is limiting liquid stream connections.

WO2018104330 discloses a process in which dissolving pulp or recycled textiles are chemically processed to produce purified material. The process has an alkali stage, an oxygen stage and an acid ozone stage. Process stages work in different pH ranges and do not give an opportunity to lead wash filtrates backwards to minimize water consumption.

Thus, there is a need for a process producing purified material comprising cellulose using chemicals, water, and other process utilities effectively, and decreasing environmental load considerably. In general, it is desirable to provide a simple, sustainable, an efficient method to produce purified material comprising cellulose and mitigating the problems of previously known solutions.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a system for decolorization of material comprising cellulose, the system comprising:
a purification stage for removing non-cellulosic components from the material comprising cellulose in alkaline process conditions; followed by
a first decolorization stage for decolorizing the material comprising cellulose in alkaline process conditions; and
a second decolorization stage for decolorizing the material comprising cellulose in alkaline process conditions; wherein
the first and second decolorization stage comprise a decolorization stage using ozone and a decolorization stage using hydrogen peroxide;
at least the purification stage and the second decolorization stage comprise a washing arrangement comprising at least one washer for washing the material treated in said stage;
each of the purification stage, the first decolorization stage and the second decolorization stage are connected to the subsequent stage by a process line for feeding the material treated and washed in said stage to the subsequent stage; and wherein
each washing arrangement is connected to the washing arrangement of a preceding stage by a filtrate line for feeding at least a part of the wash filtrate of the at least one washer of said washing arrangement to a preceding stage for use as wash water.

The system may comprise the purification stage, followed by the first decolorization stage comprising a decolorization stage using ozone, then followed by the second decolorization stage comprising a decolorization stage using hydrogen peroxide.

The system may comprise the purification stage, followed by the first decolorization stage comprising a decolorization stage using hydrogen peroxide, then followed by the second decolorization stage comprising a decolorization stage using ozone.

Each of the purification stage, the first decolorization stage and the second decolorization stage may comprise a washing arrangement comprising at least one washer for washing the material treated in said stage.

The whole system may be configured to operate in alkaline process conditions.

The material comprising cellulose may comprise textile material.

The textile material may be selected from the group of cotton, viscose and lyocell.

Each filtrate line may be further connected to the preceding process line for feeding at least a part of the wash filtrate of the at least one washer of said washer arrangement for use in dilution.

The filtrate line of each washing arrangement may be connected with at least one other filtrate line for combining at least a part of the wash filtrate of the at least one washer of said washing arrangements for use in dilution and/or as wash water.

Substantially all of the wash filtrate of the at least one washer of each washing arrangement may be used in dilution and/or as wash water.

Each process line prior to each of the purification stage, the first decolorization stage and the second decolorization stage may comprise a pump and a chemical mixer.

The chemical mixer may be configured for supplying process chemicals.

Each of the purification stage, the first decolorization stage and the second decolorization stage may comprise at least one upflow or downflow type reactor.

Each at least one washer may comprise a washer selected from the group of a drum washer, DD-washer a centrifuge, a disc filter, a drum filter, a filter press, a belt press, a twin wire press, a screw press, a wash press, and a belt washer.

The system may further comprise means for feeding the purified and decolorized textile material to further processing selected from the group of drying, a derivatization comprising carbamation or xantogenation and textile fiber manufacturing comprising a Lyocell process or Ionic liquid process.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 shows a simplified schematic block diagram of a system according to an example embodiment of the invention;

FIG. 2 shows a schematic block diagram of a system according to an example embodiment of the invention; and

FIG. 3 shows a further schematic block diagram of a system according to a further example embodiment of the invention.

### DETAILED DESCRIPTION

In the following description, like reference signs denote like elements or steps.

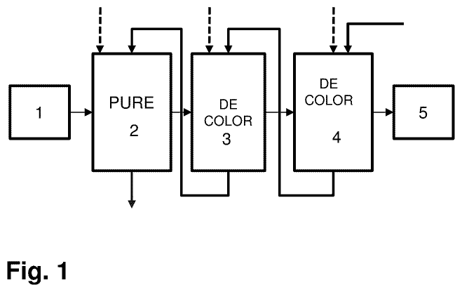

FIG. 1 shows a simplified schematic block diagram of a system according to an example embodiment. The system according to an example embodiment of the invention is working in an alkaline environment for producing purified material comprising cellulose, for example from textile material comprising scraps, pieces or garments. FIG. 1 shows the starting material, i.e. the material comprising cellulose, entering the system at 1.

FIG. 1 further shows a purification stage 2, in which non-cellulosic components, such as different type of plastics or other undesired materials are removed from the starting material chemically in alkaline process conditions. Washing of the alkali treated material is done with fresh water or wash filtrates of the following process stages.

FIG. 1 further shows a first 3 and a second 4 decolorization stage following the purification stage 2. In the example embodiment of FIG. 1, the first decolorization stage 3 comprises an ozone stage and the second decolorization stage 4 comprises a hydrogen peroxide stage. The ozone stage is configured to work in an alkaline environment. In the ozone stage, the material comprising cellulose from the previous process stage is decolorized using ozone and then washed using fresh water or wash filtrates of a following process stage or stages. Alternatively, in an embodiment, the material comprising cellulose is not washed after it has been ozonated.

The hydrogen peroxide stage is configured to work in an alkaline environment. The material comprising cellulose from the previous process stage is decolorized using hydrogen peroxide and then washed using fresh water, wash filtrates of following process stage or stages, or other suitable liquid stream or streams from a following process system such as a pulp drying process, textile fiber manufacturing process or cellulose carbamate process.

While the example embodiment of FIG. 1 shows the ozone stage 3 prior to the hydrogen peroxide stage 4, the order of these stages can be reversed in a further example embodiment of the invention. Accordingly, in the further example embodiment, the first decolorizations stage 3 comprises a hydrogen peroxide stage and the second decolorization stage 4 comprises an ozone stage.

FIG. 1 further shows the product 5 leaving the system according to an example embodiment of the invention. The product 5 is purified and decolorized material comprising cellulose which can then be transported to further processing, for example to drying, derivatization stage or to a further system or plant such as a textile manufacturing process, cellulose carbamate process, viscose process or a lyocell process.

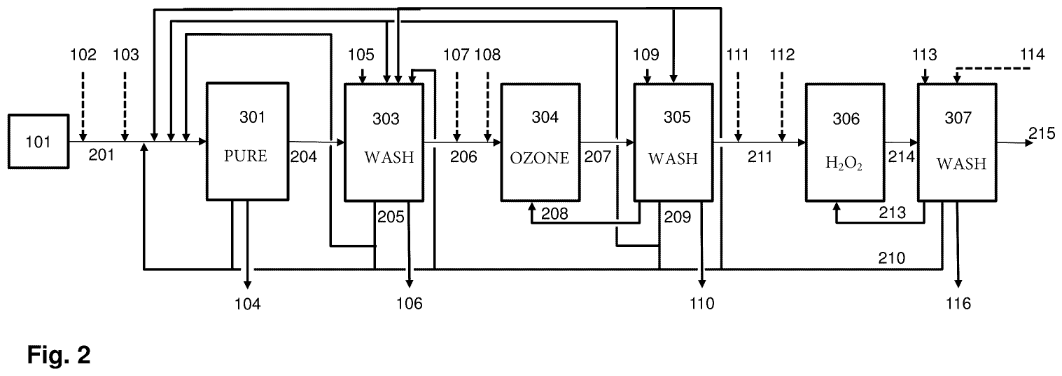

FIG. 2 shows a schematic block diagram of a system according to an example embodiment of the invention. In the following, the stages and elements comprised in the system according to an example embodiment are explained and illustrated in line with the process which the system and various parts thereof is configured to carry out. The skilled person appreciates that not all the separate devices, apparatuses and the like of the system, for example pumps, heaters and mixers are described in detail in the following as they are of a type commonly used in the industry.

In the system of FIG. 2 according to an example embodiment, material comprising cellulose 101, alkali 102, and hot water 103 are fed to process line 201 through at least one inlet respectively. The process line 201, in an embodiment, comprises a pump, a steam mixer or mixers and a chemical mixer. The type of alkali used is not limited to any specific type. In an example embodiment, NaOH is used. Hot water is used in a situation in which dilution is needed. In an example embodiment, the system comprises filtrate lines 205,209,210 for feeding the wash filtrates of following washing stages explained hereinafter separately or in form of a mixture to the process line 201 for dilution purposes and/or to minimize hot water usage, and/or to slightly decrease alkali 102 consumption depending on the alkalinity level in the first filtrate lines.

In the process line 201 the material comprising cellulose is heated with a suitable heater and mixed before pumping it to a purification stage 301. The purification stage is configured to remove non-cellulosic components, like plastics, lignin or other undesired materials. The purification stage comprises at least one purification reactor of an upflow or downflow type typically used in a chemical pulp mill fiber line. In the purification stage 301, mother liquid 104 is separated and directed to further processing, for example to be utilized in a chemical pulp mill, and/or purified and recovered to be used again. In an embodiment, a part of the mother liquid is configured to be fed to the process line 201 for use in dilution.

After the purification reactor the treated material comprising cellulose is configured to be transferred via process line 204 to a washing arrangement 303 of the purification stage. The washing arrangement 303 comprises at least one washer for washing the material previously treated. The at least one washer comprises an apparatus suitable for washing fiberlike material, for example a drum washer, a DD-washer, a centrifuge, a disc filter, a drum filter, a filter press, a belt press, a twin wire press, a screw press, a wash press, or a belt washer.

The washing arrangement 303 is configured to use hot water 105 and/or wash filtrates 209, 210 from the following stages as separately or in a form of mixture. In a further embodiment, wash filtrates 209,210 from the following washing arrangements are configured to be used as dilution liquid after the washing arrangement 303 before material comprising cellulose enters a process line 206. Since only alkaline conditions are used in the system according to the invention it is possible to process substantially all the wash filtrates to preceding process stages, without doubts of precipitates and foaming problems that occur when mixing wash filtrates having different pH levels. The wash filtrate from the washing arrangement 303 is configured to be directed to further processing 106 and/or to the purification stage 301 as dilution liquid 205. In an embodiment in which several washers are comprised in the washing arrangement 303, each washer in an embodiment comprises connections similar to those described hereinbefore, i.e. wash filtrates are configured to be directed to preceding stages to be used as wash water, or as dilution liquids.

After the washing arrangement 303 of the purification stage, the washed material is transferred to a process line 206 whereto alkali 107 and ozone 108 are configured to be fed through at least one inlet respectively. In an embodiment, the alkali content of the washed material is sufficient to maintain a desirable pH level in ozone stage, the alkali addition 107 is not needed. The process line 206 comprises a pump and a chemical mixer and the material comprising cellulose is configured to be mixed before pumping it to ozone stage 304.

The ozone stage 304, in an embodiment, operates with a pH level of about from above 7.0 to 11, preferably about 8.0-9.0 and in an example embodiment has a residence time of about 0.01 s-300.0 s., preferably about 0.1 s-120.0 s, at a pressure of about 5.0 bar-12.0 bar, preferably about 8.0 bar-10 bar. The ozone stage 304 uses an ozone dosage of about 0.5 kg/BDt-6.0 kg/BDt, preferably about 2.0 kg/BDt-4.0 kg/BDt working at a temperature of about 40 C-90 C, preferably about 50 C-70 C. The alkaline ozone stage 304 is configured to decolorize the material comprising cellulose and to prevent cellulose material viscosity decrease. Thus the chemical oxygen demand (COD) amount is decreased, i.e. organic waste load to environment is decreased. The system according to the invention is configured to maintaining a certain viscosity level which is beneficial for further use of the cellulosic material. The ozone stage 304 comprises at least one reactor of the type used in a chemical pulp mill fiberline. In an embodiment, at the end of the ozone stage 304, wash filtrate 208 of a subsequent washing arrangement 305 is used as dilution liquid.

The system according to an example embodiment of the invention is configured to feed the ozonated material comprising cellulose via a process line 207 to the subsequent washing arrangement 305 of the ozone stage. The washing arrangement 305 comprises at least one washer for washing the material previously treated. The at least one washer comprises an apparatus suitable for washing fiberlike material, for example a drum washer, a DD-washer, a centrifuge, a disc filter, a drum filter, a filter press, a belt press, a twin wire press, a screw press, a wash press, or a belt washer.

The washing arrangement 305 is configured to use hot water 109 and/or wash filtrate 210 from the following stage. In a further embodiment, wash filtrate 210 from the following washing arrangement is configured to be used as dilution liquid after the washing arrangement 305 before material comprising cellulose enters a process line 211. The wash filtrate from the washing arrangement 305 is configured to be directed to further processing 110 and/or to the ozone stage 304 as dilution liquid 208. In an embodiment in which several washers are comprised in the washing arrangement 305, each washer in an embodiment comprises connections similar to those described hereinbefore, i.e. wash filtrates are configured to be directed to preceding stages to be used as wash water, or as dilution liquids.

After the washing arrangement 305, the material comprising cellulose is fed to a process line 211. The process line 211 comprises a pump and a chemical mixer whereto alkali 111 and hydrogen peroxide 112 are configured to be fed through at least one inlet respectively before material comprising cellulose is mixed and pumped into a hydrogen peroxide stage 306. The hydrogen peroxide stage 306 is configured to decolorize the material comprising cellulose to a desired level. The hydrogen peroxide stage 306 comprises at least one upflow or downflow type reactor used in a chemical pulp mill fiber line. The hydrogen peroxide stage, in an embodiment, operates with a pH of about from above 7.0 to 11.0, preferably about 8.0-10.0, under atmospheric pressure, at a temperature of about 60 C-100 C, preferably about 70 C-90 C with in an example embodiment a residence time of about 30-120 minutes, preferably about 60 min-90 min. In an embodiment, at the end of the hydrogen peroxide stage 306, wash filtrate 213 of a subsequent washing arrangement 307 is used as dilution liquid.

The system according to an example embodiment of the invention is configured to feed the hydrogen peroxide treated material comprising cellulose via a process line 214 to the subsequent washing arrangement 307. The washing arrangement 307 comprises at least one washer for washing the material previously treated. The at least one washer comprises an apparatus suitable for washing fiberlike material, for example a drum washer, a DD-washer, a centrifuge, a disc filter, a drum filter, a filter press, a belt press, a twin wire press, a screw press, a wash press, or a belt washer. The washing arrangement 307 is configured to use hot water 113 and/or liquid 114 from the following process stage such as drying machine, cellulose derivatization stage, or from textile fiber manufacturing process like viscose or lyocell.

The wash filtrate from the washing arrangement 307 is configured to be directed to further processing 116 and/or to a preceding stage 304 as dilution liquid 213 od to previous stages via process line 210. In an embodiment in which several washers are comprised in the washing arrangement 307, each washer in an embodiment comprises connections similar to those described hereinbefore, i.e. wash filtrates are configured to be directed to preceding stages to be used as wash water, or as dilution liquids.

At the end, the system according to the invention is configured to transfer the purified and decolorized material comprising cellulose 215 to a following process stage or system. Examples of a following process stage comprise a drying process, cellulose modification stage, e.g. carbamation, and a textile fiber manufacturing process like viscose or lyocell process.

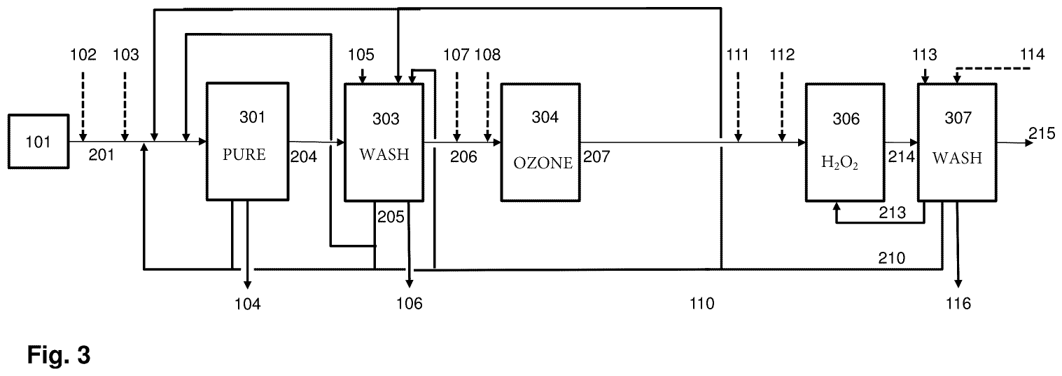

FIG. 3 shows a further schematic block diagram of a system according to a further example embodiment of the invention.

In the example embodiment shown in FIG. 3, the system does not comprise a washing arrangement after the ozone stage 304. Accordingly, the material comprising cellulose being treated is fed via a process line 207 after ozone stage 304 to the second decolorizing stage 306. In such an embodiment, the number of the process devices is minimized, and the amount of washing water and wastewater is further decreased. In the embodiment of FIG. 3 the system comprises similar components and functionalities as described hereinbefore with reference to FIG. 2 except the components relating to the washing arrangement 305 are omitted.

In a still further example embodiment of the invention, unlike described hereinbefore with reference to FIGS. 2 and 3, the first decolorizations stage 304 comprises a hydrogen peroxide stage and the second decolorizations stage 306 comprises an ozone stage. In such an embodiment, the system comprises similar components and functionalities as described hereinbefore with reference to FIGS. 2 and 3 except the decolorization stages are in reverse order and accordingly also the chemical feeds thereinto.

Without in any way limiting the scope of the appended claims, some technical effects of the system according to example embodiment of the invention are explained in the following.

The system according to example embodiments of the invention shown in FIGS. 1-3 is configured to minimize the fresh water consumption and thus to increase process efficiency by using an alkaline environment in all of the purification stage and the first and the second decolorization stage and by exploiting various liquid streams in diluting and washing. The system according to example embodiments of the invention shown in FIGS. 1-3 is further configured to minimize process system effluent amount considerably comparing to other existing processes and thus to have a lower environmental impact. Furthermore, according to example embodiments of the invention, alkali consumption will also decrease, as utilization of alkalinity of whole process system is possible due to liquid circulation.

Accordingly, a technical effect of example embodiment of the invention is to remove disadvantages in the prior art, and to improve purification process of the material comprising cellulose. A further technical effect of the example embodiments of the invention is to decrease water and chemical consumption as well as to decrease the amount of effluent.

Various embodiments of the invention have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A system for decolorization of material comprising cellulose, the system comprising:
a purification stage configured to remove non-cellulosic components from the material comprising cellulose in alkaline process conditions;
a first decolorization stage downstream of the purification stage in a flow of the material comprising cellulose and configured to decolorize the material comprising cellulose in alkaline process conditions; and
a second decolorization stage downstream of the purification stage and in series with the first decolorization stage, wherein the second decolorization stage is configured to decolorize the material comprising cellulose in alkaline process conditions;
the first or the second decolorization stage uses ozone to decolorize the material comprising cellulose and the other of the first or the second decolorization stage uses hydrogen peroxide to decolorize the material comprising cellulose;
at least the purification stage and the second decolorization stage each comprise a respective washing arrangement comprising at least one washer configured to wash the material comprising cellulose treated in the purification stage or, respectively, the second decolorization stage;
process lines fluidically connecting the purification stage, the first decolorization stage and the second decolorization stage, wherein the process lines feed the material comprising cellulose between the purification stage, the first decolorization stage and the second decolorization stage, and
wherein the washing arrangement in the second decolorization stage is fluidically connected to the washing arrangement of the purification stage by a filtrate line which feeds wash filtrate from the washing arrangement in the second decolorization stage to be used as wash water in the washing arrangement for the purification stage.

2. The system for decolorization of material comprising cellulose according to claim 1, wherein the purification stage is followed by the first decolorization stage, the first decolorization stage uses the ozone to decolorize the material comprising cellulose, the second decolorization stage follows the first decolorization stage, and the second decolorization stage uses the hydrogen peroxide to decolor the material comprising cellulose.

3. The system for decolorization of material comprising cellulose according to claim 1, wherein the purification stage is upstream in the flow of the material comprising cellulose with respect to the first decolorization stage, wherein the first decolorization stage uses the hydrogen peroxide, and
the second decolorization stage uses the ozone and the second decolorization stage is downstream of the first decolorization stage.

4. The system for decolorization of material comprising cellulose according to claim 1, wherein each of the purification stage, the first decolorization stage and the second decolorization stage comprise the washing arrangement comprising at least one washer for washing the material treated in said stage.

5. The system for decolorization of material comprising cellulose according to claim 1, wherein each of the purification stage, the first decolorization stage and the second decolorization stage are configured to operate in alkaline process conditions.

6. The system for decolorization of material comprising cellulose according to claim 1, wherein the material comprising cellulose comprises textile material.

7. The system for decolorization of material comprising cellulose according to claim 6, wherein the textile material is at least one of cotton, viscose or lyocell.

8. The system for decolorization of material comprising cellulose according to claim 1, wherein each filtrate line is further connected to the preceding process line for feeding at least a part of the wash filtrate of the at least one washer of said washer arrangement for use in dilution.

9. The system for decolorization of material comprising cellulose according to claim 1, wherein the filtrate line of each of the washing arrangements is connected with at least one filtrate line from another one of the washing arrangements for combining at least a part of the wash filtrate of the at least one washer of said washing arrangements for use in dilution and/or as wash water.

10. The system for decolorization of material comprising cellulose according to claim 1, wherein substantially all of the wash filtrate of the at least one washer of each washing arrangement is used in dilution and/or as wash water.

11. The system for decolorization of material comprising cellulose according to claim 1, wherein each process line prior to each of the purification stage, the first decolorization stage and the second decolorization stage comprises a pump and a chemical mixer.

12. The system for decolorization of material comprising cellulose according to claim 9, wherein the chemical mixer is configured to supply process chemicals.

13. The system for decolorization of material comprising cellulose according to claim 1, wherein each of the purification stage, the first decolorization stage and the second decolorization stage comprise at least one upflow or downflow type reactor.

14. The system for decolorization of material comprising cellulose according to claim 1, wherein each at least one washer comprises at least one of: a drum washer, a DD-washer, a centrifuge, a disc filter, a drum filter, a filter press, a belt press, a twin wire press, a screw press, a wash press, or a belt washer.

15. The system for decolorization of material comprising cellulose according to claim 1, wherein the system further comprises means for feeding the material comprising cellulose after flowing through the purification stage, the first decolorization stage and the second decolorization stage to further processing selected from the group of drying, a derivatization comprising carbamation or xantogenation and textile fiber manufacturing comprising a Lyocell process or Ionic liquid process.

16. A method to decolorization a material, the method comprising:
removing, under alkaline conditions, non-cellulosic components from a textile material to generate a purified cellulosic material from the textile material;
washing the purified cellulosic material in a first washing step,
after the first washing step, decolorizing the purified cellulosic material using ozone in a first decolorization stage operating in alkaline process conditions;
decolorizing the purified cellulosic material in a second decolorization stage with hydrogen peroxide,
washing, in a second washing step, the purified cellulosic material after at least one of the first decolorization stage or the second decolorization stage, and
feeding wash filtrate from the second washing step to the first washing step to be used to wash the purified cellulosic material during the first washing step.

17. The method of claim 16, wherein the first decolorization step and the second decolorization step operate in alkaline process conditions.

18. The method of claim 16, further comprising combining the wash filtrate from second washing step with wash filtrate from the first washing step and using the combined wash filtrate as dilution liquid in the step of removing non-cellulosic components from a textile material

19. The method of claim 16, further comprising processing the purified cellulosic material downstream of the first decolorization stage and the second decolorization stage, wherein the processing includes at least one of: drying, a derivatization comprising carbamation or xantogenation, or textile fiber manufacturing comprising a Lyocell process or Ionic liquid process.
